(19) United States
(12) Patent Application Publication
(10) Pub. No.: US 2006/0023713 A1
(43) Pub. Date: Feb. 2, 2006

(54) Retransmission control method and apparatus using the same

(75) Inventors: Hyun-seok Choi, Seoul (KR); Jun-hwan Kim, Seoul (KR); Hyong-uk Choi, Seoul (KR); Yong-jun Lim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/179,629

(22) Filed: Jul. 13, 2005

(30) Foreign Application Priority Data
Jul. 13, 2004 (KR) 10-2004-0054498

(51) Int. Cl. H04L 12/56

(52) U.S. Cl. 370/389; 370/252; 714/746

(57) ABSTRACT

Provided are a method of controlling frame transmission in a wireless local area network (WLAN) and an apparatus using the same. A first retransmission control method includes: comparing the number of errors in a frame received from a server with a predetermined threshold; and adaptively not allowing retransmission of the frame on the basis of the comparison result. Therefore, optimal pictures can be provided without regard to a state of a WLAN environment by adaptively allowing retransmission frames in which errors are detected.

### CROSS-REFERENCE TO RELATED APPLICATIONS

This application claims the priority of Korean Patent Application No. 10-2004-0054498, filed on Jul. 13, 2004, in the Korean Intellectual Property Office, the disclosure of which is incorporated herein in its entirety by reference.

### BACKGROUND OF THE INVENTION

1. Field of the Invention

The present invention relates to a method of controlling frame transmission in a wireless local area network (WLAN) and an apparatus using the same.

2. Description of the Related Art

In WLAN environments, an error rate is high and a bandwidth is narrow as compared with wired LAN environments. Considering the characteristics of WLAN environments, much research is being carried out on smooth transmission of AV(audio visual) data.

In a conventional frame transmission control method, since all frame errors are detected in a media access control (MAC) layer and retransmission of frames in which errors have been detected is attempted, traffic over a narrow bandwidth of the WLAN environment is increased, and network throughput is dramatically decreased.

Also, since an Internet protocol (IP) checksum and a user datagram protocol (UDP) checksum are performed in an IP layer and a UDP layer, respectively, the checksums use a lot of CPU processing power.

### SUMMARY OF THE INVENTION

The present invention provides a method of controlling retransmission to always provide optimal images without regard to a state of a WLAN environment, and an apparatus using the same.

The present invention also provides a computer readable medium having recorded thereon a computer readable program for performing the method.

According to an aspect of the present invention, there is provided a first retransmission control method comprising: comparing a number of errors in a frame received from a server with a predetermined threshold; and adaptively not allowing retransmission of the frame on the basis of the comparison result.

According to another aspect of the present invention, there is provided a first retransmission control apparatus comprising: a comparator comparing a number of errors in a frame received from a server with a predetermined threshold; and a retransmission disallowance unit adaptively not allowing retransmission of the frame on the basis of the comparison result.

According to another aspect of the present invention, there is provided a second retransmission control method comprising: comparing a number of errors in a frame received from a server with a retransmission disallowance threshold for not allowing retransmission of the frame; and changing a retransmission disallowance mode in which retransmission of the frame is not allowed to a retransmission allowance mode in which retransmission of the frame is allowed, if it is determined that the number of errors in the frame is greater than the retransmission disallowance threshold based on the comparison result.

According to another aspect of the present invention, there is provided a second retransmission control apparatus comprising: a comparator comparing a number of errors in a frame received from a server with a retransmission disallowance threshold for not allowing retransmission of the frame; and a mode changer changing a retransmission disallowance mode in which retransmission of the frame is not allowed to a retransmission allowance mode in which retransmission of the frame is allowed, if it is determined that the number of errors in the frame is greater than the retransmission disallowance threshold based on the comparison result.

According to another aspect of the present invention, there is provided a computer readable medium having recorded thereon a computer readable program for performing the first retransmission control method.

According to another aspect of the present invention, there is provided a computer readable medium having recorded thereon a computer readable program for performing the second retransmission control method.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph illustrating a UDP packet error rate in a wireless LAN environment;

FIG. 2 is a diagram illustrating protocol stacks of a client and a server;

FIG. 3 is a block diagram of a retransmission control apparatus according to an embodiment of the present invention;

FIG. 4 is a diagram of a frame format according to an embodiment of the present invention;

FIG. 5 is a chart illustrating thresholds corresponding to frame data rates in an experiment according to an embodiment of the present invention;

FIG. 6 is a diagram illustrating a beacon frame format;

FIG. 7 is a diagram illustrating an IP header format;

FIG. 8 is a diagram illustrating a UDP datagram format;

FIGS. 9, 10 and 11 are flowcharts illustrating a retransmission control method according to an embodiment of the present invention;

FIG. 12 illustrates a program according to an embodiment of the present invention; and

FIGS. 13 and 14 are experimental pictures according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

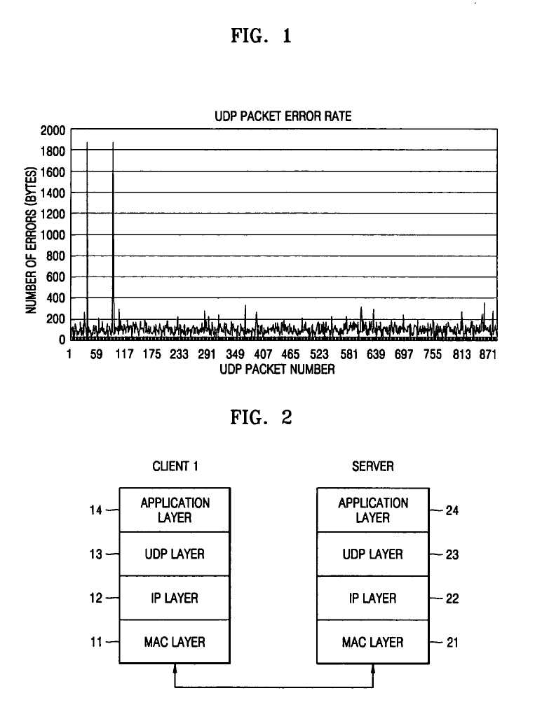

FIG. 1 illustrates a UDP packet error rate in a wireless LAN environment. Referring to FIG. 1, the number of errors for each of 900 consecutive UDP packets in a WLAN environment are shown. Errors below 10% are detected for around 90% of the 900 UDP packets. Conventionally, retransmission is performed for all UDP packets for which errors are detected. According to FIG. 1, errors are not detected for around 10% of the 900 UDP packets, errors below 10% are detected for around 80% of the 900 UDP packets except the 10% of the 900 UDP packets for which errors are not detected, and errors more than 10% are detected for the other UDP packets. Therefore, around 90% of the 900 UDP packets become objects to be retransmitted.

In general, AV data, which is sensitive to a data arriving time rather than a data loss, is transmitted using UDP packets. A UDP does not provide an error correction or retransmission function like a transmission control protocol (TCP). That is, the UDP is used for data transmission, which requires high speed rather than reliability. On the contrary, the TCP is used for transmission of data requiring reliability rather than high speed, i.e., general data such as text files and program files.

Due to characteristics of AV data, AV data including a few errors has almost the same quality as AV data including no errors. Therefore, if retransmission is not allowed for AV data including a few errors, AV streams can be smoothly reproduced with almost the same quality as the original ones. Since checksums of frames of IP and UDP layers that are not allowed to be retransmitted are meaningless, disabling this checksum function will help to increase CPU performance.

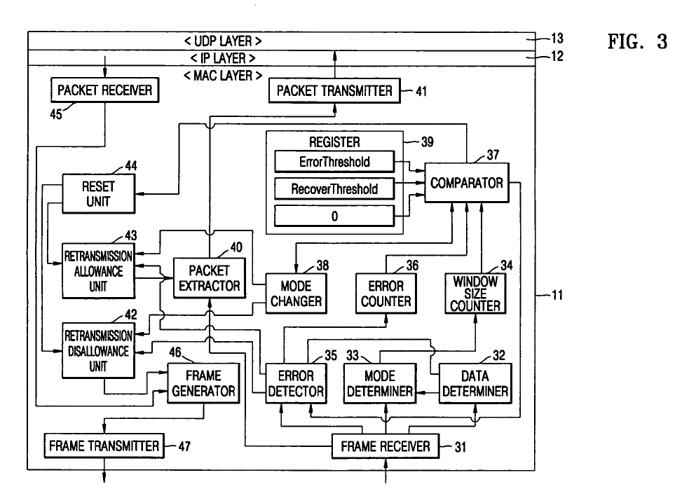

FIG. 2 illustrates protocol stacks of a client 1 and a server 2. Referring to FIG. 2, a protocol stack of the client 1 includes a MAC layer 11, an IP layer 12, a UDP layer 13, and an application layer 14, and a protocol stack of the server 2 includes a MAC layer 21, an IP layer 22, a UDP layer 23, and an application layer 24.

When the application layer 14 of the client 1 requests AV data transmission from the server 2, this request is transmitted to the server 2 in a frame pattern by passing through the UDP layer 13, the IP layer 12, and the MAC layer 11. After the MAC layer 21 of the server 2 receives the frame transmitted from the client 1, the request included in the frame arrives at the application layer 24 by passing through the IP layer 22 and the UDP layer 23.

The application layer 24 of the server 2 transmits AV data in response to the request, and the AV data is transmitted to the client 1 in the frame pattern by passing through the UDP layer 23, the IP layer 22, and the MAC layer 21. After the MAC layer 11 of the client 1 receives the frame transmitted from the server 2, the AV data included in the frame arrives at the application layer 14 by passing through the IP layer 12 and the UDP layer 13.

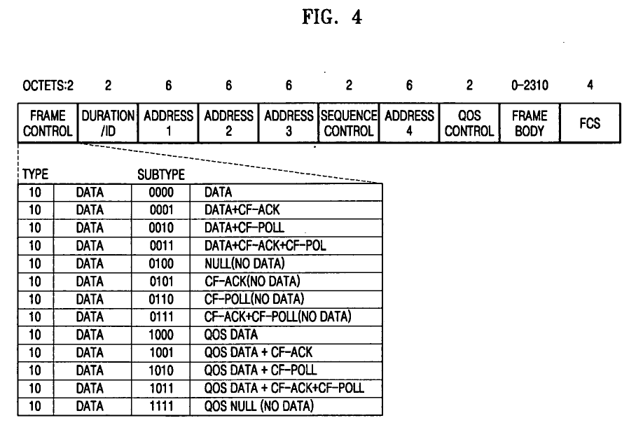

FIG. 3 is a block diagram of a retransmission control apparatus according to an embodiment of the present invention. Referring to FIG. 3, the retransmission control apparatus includes a frame receiver 31, a data determiner 32, a mode determiner 33, a window size counter 34, an error detector 35, an error counter 36, a comparator 37, a mode changer 38, a register 39, a packet extractor 40, a packet transmitter 41, a retransmission disallowance unit 42, a retransmission allowance unit 43, a reset unit 44, a packet receiver 45, a frame generator 46, and a frame transmitter 47. The retransmission control apparatus is installed in the MAC layer 11 illustrated in FIG. 2. The frame receiver 31 receives a frame from the server 2. The data determiner 32 determines the kinds of data included in the frame received by the frame receiver 31.

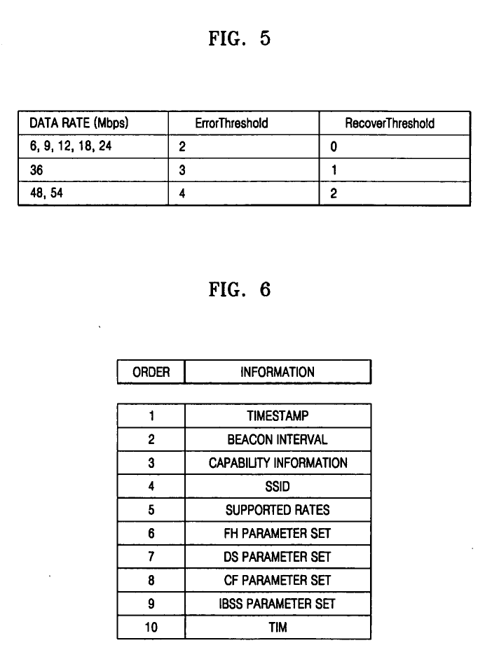

FIG. 4 illustrates a frame format according to an embodiment of the present invention. Referring to FIG. 4, the frame includes a frame control field, a duration field, a first address field, a second address field, a third address field, a sequence control field, a quality of service (QoS) control field, a frame body field, and a frame check sequence field. Here, the frame control field includes a type field, a subtype field, and other fields. According to the IEEE 802.11 standard, when a value recorded in a type field of a frame is 10, this indicates that this frame is a data frame, and when a value recorded in a subtype field of the data frame is 1000 to 1100, this indicates that data included in the data frame is QoS data, i.e., AV data.

Therefore, the data determiner 32 can determine the kinds of data included in the frame received by the frame receiver 31 with reference to values recorded in the type and subtype fields of the frame.

When it is determined by the data determiner 32 that the data included in the frame is AV data, the mode determiner 33 determines whether a current mode is a retransmission allowance mode, which allows retransmission of the frame, or a retransmission disallowance mode, which does not allow the retransmission of the frame. According to the present embodiment, even if a few errors occur on AV data during transmission in a current WLAN environment, when the AV data including a few errors can be reproduced with almost the same quality as AV data including no errors, the mode determiner 33 determines that the current mode is the retransmission disallowance mode by responding with an ‘ACK(acknowledge)’ as if a frame in which errors occurred has normally been received. Also, when AV data cannot be normally reproduced if frames in which errors occurred are not received again since many errors occur on the AV data during transmission in the current WLAN environment, the mode determiner 33 determines that the current mode is the retransmission allowance mode.

When the retransmission allowance mode is determined by the mode determiner 33, the window size counter 34 decreases a count value WindowSize for a window size of the retransmission allowance mode. Also when the retransmission disallowance mode is determined by the mode determiner 33, the window size counter 34 decreases the count value WindowSize for a window size of the retransmission disallowance mode. The window size is the number of frames which can be consecutively transmitted without waiting for responses from the other party. The error counter 36 counts the number of errors in the frames within the window.

When it is determined by the data determiner 32 that the data included in the frame is not AV data but general data, the error detector 35 detects errors in the frame received by the frame receiver 31. In the frame check sequence field shown in FIG. 4, parity information for error detection and cyclic redundancy check (CRC) information are included. That is, the error detector 35 detects errors with reference to values recorded in the frame check sequence field shown in FIG. 4.

Also, when the count value WindowSize decreased by the window size counter 34 is determined to be greater than 0 recorded in the register 39 based on the comparison results of the comparator 37, or when a reset process is finished by the reset unit 44, the error detector 35 detects the errors in the frame received by the frame receiver 31.

If errors are detected in a frame including AV data by the error detector 35 when the current mode is the retransmission allowance mode, the error counter 36 increases a count value RecoverCount used to change the retransmission allowance mode to the retransmission disallowance mode. Also, if errors are detected in a frame including AV data by the error detector 35 when the current mode is the retransmission disallowance mode, the error counter 36 increases a count value ErrorCount used to change the retransmission disallowance mode to the retransmission allowance mode.

The comparator 37 compares the counter value WindowSize decreased by the window size counter 34 with 0 recorded in the register 39. Also, when the current mode is the retransmission allowance mode, the comparator 37 compares the counter value RecoverCount increased by the error counter 36 with a retransmission allowance threshold RecoverThreshold recorded in the register 39. When the current mode is the retransmission disallowance mode, the comparator 37 compares the counter value ErrorCount increased by the error counter 36 with a retransmission disallowance threshold ErrorThreshold recorded in the register 39.

If the counter value RecoverCount increased by the error counter 36 is determined to be smaller than RecoverThreshold based on the comparison results of the comparator 37 when the current mode is the retransmission allowance mode, the mode changer 38 changes the retransmission allowance mode to the retransmission disallowance mode. Also, if the counter value ErrorCount increased by the error counter 36 is determined to be greater than ErrorThreshold based on the comparison results of the comparator 37 when the current mode is the retransmission disallowance mode, the mode changer 38 changes the retransmission disallowance mode to the retransmission allowance mode.

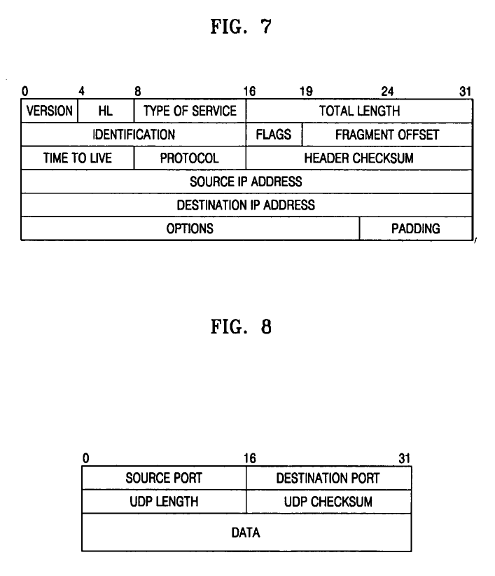

FIG. 5 illustrates thresholds corresponding to frame data rates in an experiment according to an embodiment of the present invention. Referring to FIG. 5, the retransmission disallowance thresholds ErrorThreshold and the retransmission allowance thresholds RecoverThreshold according to various frame data rates are obtained by an experiment according to the present embodiment. In the experiment, the window size is set to ‘5’. For example, if the data rate is 48 Mbps and the current mode is the retransmission disallowance mode, if errors are detected for more than 4 frames among 5 frames, the mode changer 38 changes the retransmission disallowance mode to the retransmission allowance mode. That is, when it is determined that the WLAN environment is bad according to a current error detection status, even if the current mode is the retransmission disallowance mode, the retransmission disallowance mode is changed to the retransmission allowance mode.

On the other hand, if the data rate is 48 Mbps and the current mode is the retransmission allowance mode, if errors are detected for less than 2 frames among 5 frames, the mode changer 38 changes the retransmission allowance mode to the retransmission disallowance mode. That is, when it is determined that the WLAN environment is good according to a current error detection status, even if the current mode is the retransmission allowance mode, the retransmission allowance mode is changed to the retransmission disallowance mode.

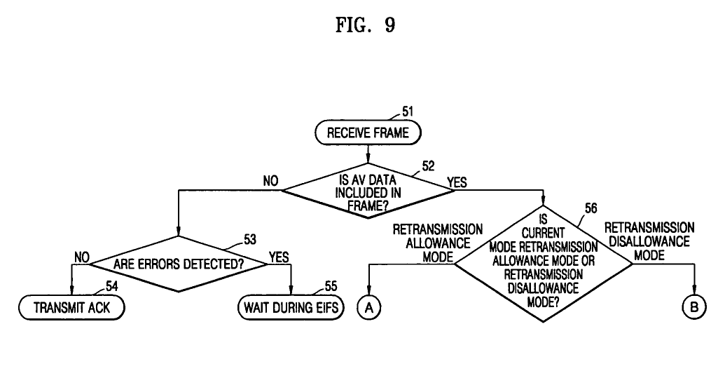

FIG. 6 illustrates a beacon frame format. According to the IEEE 802.11 standard, the type field value of a beacon frame is 0, and a subtype field value of the beacon frame is 1000. Referring to FIG. 6, a frame body field of the beacon frame includes a timestamp field, a beacon interval field, a capability information field, a service set identity (SSID) field, a supported rates field, and others. Information on the data rates is recorded in the supported rates field of the frame body field of the beacon frame.

The register 39 outputs the retransmission allowance threshold RecoverThreshold and the retransmission disallowance threshold ErrorThreshold corresponding to a current data rate with reference to the value recorded in the supported rates field of the frame body field of the beacon frame.

The packet extractor 40 extracts an IP packet from the frame received by the frame receiver 31. When the retransmission disallowance unit 42 has disabled checksum functions of the IP layer 12 and the UDP layer 13, the packet extractor 40 extracts the IP packet in which the checksum function is disabled by the retransmission disallowance unit 42. The packet transmitter 41 transmits the IP packet extracted by the packet extractor 40 to the IP layer 12.

The retransmission disallowance unit 42 does not allow retransmission of a frame, by transmitting ‘ACK’ to the server 2 when errors are not detected in the frame including general data (not AV data) by the error detector 35. Also, the retransmission disallowance unit 42 does not allow retransmission of a frame, by transmitting ‘ACK’ to the server 2 when errors are not detected in the frame including AV data by the error detector 35. That is, the retransmission disallowance unit 42 transmits ‘ACK’ to the server 2 so that the server 2 does not retransmit the same frame for the frame in which errors are not detected. Here, the retransmission disallowance unit 42 transmits ‘ACK’ to the server 2 by commanding the frame generator 46 to generate a frame indicating ‘ACK’.

When the counter value ErrorCount increased by the error counter 36 is determined to be smaller than ErrorThreshold based on the comparison results of the comparator 37, the retransmission disallowance unit 42 does not allow the retransmission of the frame by disabling the checksum functions of the IP layer 12 and the UDP layer 13 which are upper layers of the MAC layer 11 processing frames. Also, when the disabling of the checksum functions is finished, or when the current mode is changed to the retransmission disallowance mode by the mode changer 38 and a reset process is finished by the reset unit 44, the retransmission disallowance unit 42 does not allow the retransmission of the frame, by transmitting ‘ACK’ to the server 2. In other words, the retransmission disallowance unit 42 does not allow the retransmission of the frame, by transmitting ‘ACK’ to the server 2 even if a normal frame instead of the frame in which errors are detected is not received again.

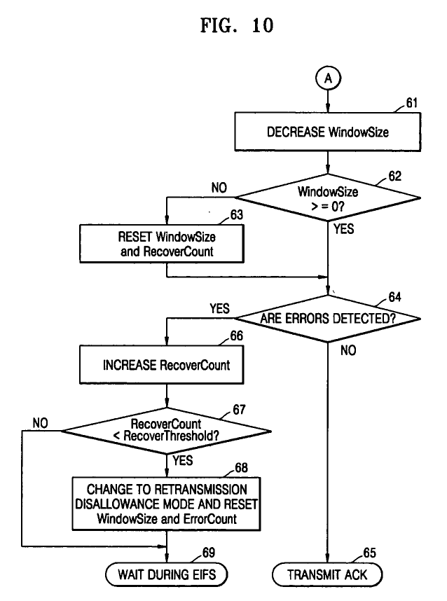

FIG. 7 illustrates an IP header format. Referring to FIG. 7, an IP header includes a version field, a header length field, a type of service field, a total length field, an identification field, a flag field, a fragment offset field, a time to live field, a protocol field, a header checksum field, a source address field, a destination address field, an option field, and a padding field.

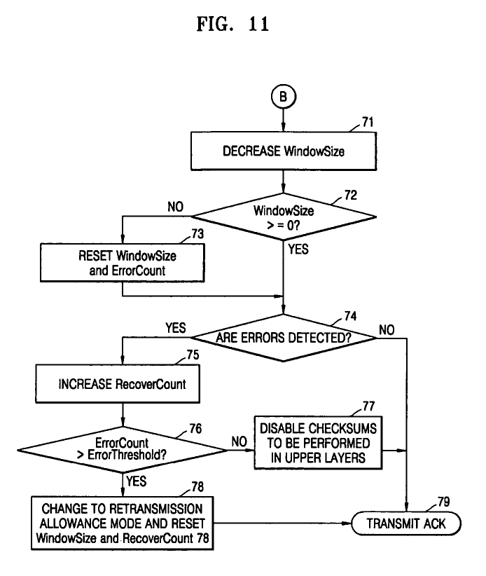

FIG. 8 illustrates a UDP datagram format. Referring to FIG. 8, a UDP datagram includes a source port field, a destination port field, a UDP length field, a UDP checksum field, and a data field. The retransmission disallowance unit 42 can disable the checksum functions of the IP layer 12 and the UDP layer 13 by writing a value indicating “disable”, e.g., 0, in the header checksum field of the IP header shown in FIG. 7 and the UDP checksum field of the UDP datagram shown in FIG. 8.

As shown in FIGS. 7 and 8, since locations of the checksum fields of the IP header and the UDP datagram are always fixed, the value indicating “disable” can be written in the checksum fields of the IP header and the UDP datagram without performing analysis of the IP packet and the UDP datagram in the IP layer 12 and the UDP layer 13.

The retransmission allowance unit 43 allows retransmission of a frame by waiting to receive the frame retransmitted from the server 2 during an extended interframe space (EIFS) when errors are detected in the frame including general data (not AV data) by the error detector 35. Also, when the counter value RecoverCount increased by the error counter 36 is determined not to be smaller than RecoverThreshold based on the comparison results of the comparator 37, or when the current mode is changed to the retransmission allowance mode by the mode changer 38 and a reset process is finished by the reset unit 44, the retransmission allowance unit 43 allows the retransmission of the frame by waiting to receive the frame retransmitted from the server 2 during the EIFS.

When the counter value WindowSize decreased by the window size counter 34 is determined to be less than 0 based on the comparison results of the comparator 37, and when the current mode is the retransmission allowance mode, the reset unit 44 resets the counter value WindowSize for the retransmission allowance mode and the count value RecoverCount for the change to the retransmission disallowance mode. Also, when the counter value RecoverCount increased by the error counter 36 is determined to be smaller than RecoverThreshold based on the comparison results of the comparator 37, the reset unit 44 resets the count value ErrorCount for the change to the retransmission allowance mode.

When the counter value WindowSize decreased by the window size counter 34 is determined to be less than 0 based on the comparison results of the comparator 37, and when the current mode is the retransmission disallowance mode, the reset unit 44 resets the counter value WindowSize for the retransmission disallowance mode and the count value ErrorCount for the change to the retransmission allowance mode. Also, when the counter value ErrorCount increased by the error counter 36 is determined to be smaller than ErrorThreshold based on the comparison results of the comparator 37, the reset unit 44 resets the count value RecoverCount for the change to the retransmission disallowance mode. The reset unit 44 can reset the counter value WindowSize, the count value ErrorCount, and the count value RecoverCount by writing 0, RecoverCount, and ErrorCount in the register 39.

The packet receiver 45 receives an IP packet from the IP layer 12. For example, the packet receiver 45 receives the IP packet for requesting transmission of AV data.

Depending on a command from the retransmission disallowance unit 42, the frame generator 46 generates a frame by adding an MAC header to the IP packet received by the packet receiver 45 or generates a frame indicating ‘ACK’. The frame transmitter 47 transmits the frame generated by the frame generator 46 to the sever 2.

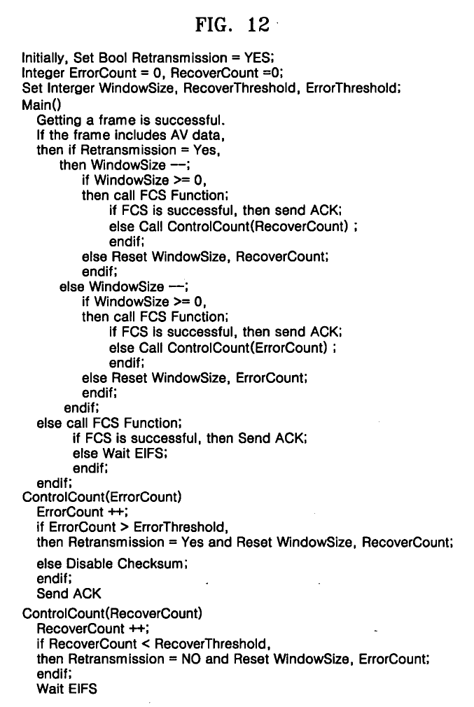

FIGS. 9, 10 and 11 are flowcharts illustrating a retransmission control method according to an embodiment of the present invention. Referring to FIGS. 9, 10 and 11, the retransmission control method includes operations 51 through 56, 61 through 69, and 71 through 79. The retransmission control method is composed of sequentially processed operations, processed by the retransmission control apparatus shown in FIG. 3. Therefore, although a description of the retransmission control method is omitted, the description related to the retransmission control apparatus shown in FIG. 3 can also be applied to the retransmission control method.

In operation 51, the client 1 receives a frame from the server 2. In operation 52, the client 1 determines kinds of data included in the frame received in operation 51. In operation 53, the client 1 detects errors in the frame received in operation 51 if it is determined that the data is general data (notAV data) in operation 52. In operation 54, the client 1 does not allow retransmission of the frame received in operation 51 by transmitting ‘ACK’ to the server 2, if the errors are not detected in operation 53.

In operation 55, the client 1 allows retransmission of the frame received in operation 51 by waiting to receive a frame retransmitted from the server 2 during the EIFS, if the errors are detected in operation 53. In operation 56, the client 1 determines whether a current mode is the retransmission allowance mode, which allows the retransmission of the frame received in operation 51, or the retransmission disallowance mode, which does not allow the retransmission of the frame received in operation 51, if it is determined that the data is AV data in operation 52.

In operation 61, the client 1 decreases a count value WindowSize for a window size of the retransmission allowance mode if it is determined that the current mode is the retransmission allowance mode in the operation 56. In operation 62, the client 1 compares the count value WindowSize decreased in operation 61 with 0. In operation 63, the client 1 resets the counter value WindowSize for the retransmission allowance mode and the count value RecoverCount for the change to the retransmission disallowance mode, if it is determined that the count value WindowSize decreased in operation 61 is less than 0 based on the results compared in operation 62.

In operation 64, the client 1 detects errors in the frame received in operation 51 if the count value WindowSize decreased in operation 61 is equal to or more than 0, or if the reset process in operation 63 is finished. In operation 65, the client 1 does not allow the retransmission of the frame received in operation 51 by transmitting ‘ACK’ to the server 2 if errors are not detected in operation 64. In operation 66, the client 1 increases the count value RecoverCount for the change to the retransmission disallowance mode if errors are detected in operation 64.

In operation 67, the client 1 compares the count value RecoverCount increased in operation 66 to the retransmission allowance threshold RecoverThreshold. In operation 68, the client 1 changes the retransmission allowance mode to the retransmission disallowance mode and resets the count value ErrorCount for the change to the retransmission allowance mode if it is determined that the count value RecoverCount increased in operation 66 is smaller than the retransmission allowance threshold RecoverThreshold based on the results compared in operation 67.

In operation 69, the client 1 allows the retransmission of the frame received in operation 51 by waiting to receive a frame retransmitted from the server 2 during the EIFS(Extended Interframe Space) if it is determined that the count value RecoverCount increased in operation 66 is not smaller than the retransmission allowance threshold RecoverThreshold based on the results compared in operation 67 or if the change and reset processes in operation 68 are finished.

In operation 71, the client 1 decreases the count value WindowSize for a window size of the retransmission disallowance mode if it is determined that the current mode is the retransmission disallowance mode in the operation 56. In operation 72, the client 1 compares the count value WindowSize decreased in operation 71 to 0. In operation 73, the client 1 resets the counter value WindowSize for the retransmission disallowance mode and the count value ErrorCount for the change to the retransmission allowance mode if it is determined that the count value WindowSize decreased in operation 71 is less than 0 based on the results compared in operation 72.

In operation 74, the client 1 detects errors in the frame received in operation 51 if the count value WindowSize decreased in operation 71 is equal to or more than 0, or if the reset process in operation 73 is finished. In operation 75, the client 1 increases the count value ErrorCount for the change to the retransmission allowance mode if errors are detected in operation 74. In operation 76, the client 1 compares the count value ErrorCount increased in operation 75 with the retransmission disallowance threshold ErrorThreshold.

In operation 77, the client 1 does not allow the retransmission of the frame received in operation 51 by disabling checksum functions of upper layers if it is determined that the count value ErrorCount increased in operation 75 is not smaller than the retransmission disallowance threshold ErrorThreshold based on the results compared in operation 76.

In operation 78, the client 1 changes the retransmission disallowance mode to the retransmission allowance mode and resets the count value RecoverCount for the change to the retransmission disallowance mode if it is determined that the count value ErrorCount increased in operation 75 is smaller than the retransmission disallowance threshold ErrorThreshold based on the results compared in operation 76.

In operation 79, the client 1 does not allow the retransmission of the frame received in operation 51 by transmitting ‘ACK’ to the server 2 if errors are not detected in operation 74, if the disable of the checksum functions in operation 77 is finished, or if the change and reset processes are finished in operation 78.

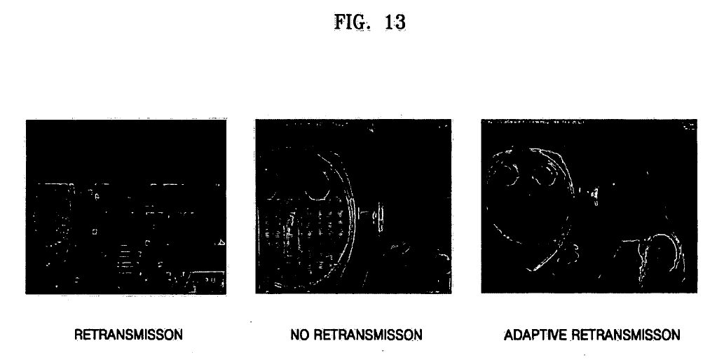

FIG. 12 illustrates a program according to an embodiment of the present invention. Referring to FIG. 12, the program is embodied with pseudo codes. The program is realized as an actual program according to the retransmission control method shown in FIGS. 9, 10 and 11. The retransmission control apparatus shown in FIG. 3 can be realized by applying the present program to a mobile station existing in a WLAN environment.

Initially, Set Bool Retransmission = YES;
Integer ErrorCount = 0, RecoverCount =0;
Set Integer WindowSize, RecoverThreshold, ErrorThreshold;

The above three lines are a process of setting an initial state.

Getting a frame is successful.

The above line corresponds to operation 51.

If the frame includes AV data,

The above line corresponds to operation 52.

then if Retransmission = Yes,

then WindowSize −−;

if WindowSize >= 0,
then call FCS Function;

if FCS is successful, then send ACK;
else Call ControlCount(RecoverCount) ;
endif;

else Reset WindowSize, RecoverCount;
endif;

The above nine lines correspond to FIG. 10.

else WindowSize −−;

if WindowSize >= 0,
then call FCS Function;

if FCS is successful, then send ACK;
else Call ControlCount(ErrorCount) ;
endif;

else Reset WindowSize, ErrorCount;
endif;

endif;

The above nine lines correspond to FIG. 11.
else call FCS Function;

if FCS is successful, then Send ACK;
else Wait EIFS;
endif;

endif;
The above five lines correspond to operations 53 through 55.
ControlCount(ErrorCount)

ErrorCount ++;
if ErrorCount > ErrorThreshold,
then Retransmission = Yes and Reset WindowSize,
RecoverCount;
else Disable Checksum;
endif;
Send ACK

The above seven lines correspond to operations 75 through 79.
ControlCount(RecoverCount)

RecoverCount ++;
if RecoverCount < RecoverThreshold,
then Retransmission = NO and Reset WindowSize, ErrorCount;
endif;
Wait EIFS

The above six lines correspond to operations 66 through 69.

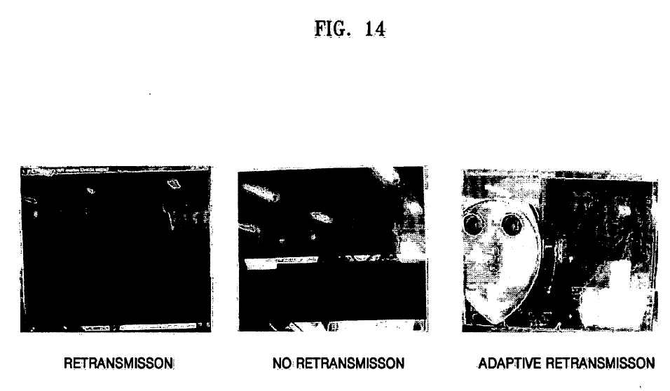

FIGS. 13 and 14 illustrate experimental pictures according to an embodiment of the present invention. An experimental environment for obtaining the experimental pictures shown in FIGS. 13 and 14 will now be described. Data (6 Mbps) having DVD quality is adopted as source data. A WLAN environment in which a 9 Mpps (packet per second) infrastructure mode, a no power save mode, and a distribution coordination function (DCF) only mode are set is adopted. A network environment in which an AP transmits data to a station is adopted. Also, a computer environment in which a 2.4 MHz Pentium Processor and 512M RAM are included is adopted.

FIG. 13 shows experimental pictures in a WLAN environment having middle quality. In the WLAN environment having middle quality, a few errors are detected, and picture quality is almost the same no matter what kind of retransmission method is selected. Therefore, referring to FIG. 13, a picture located on the left according to a retransmission method is partially damaged due to retransmission of frames in which errors are detected. A picture located in the center according to a non-retransmission method is clean since retransmission of a few frames in which errors are detected is not allowed. Like the non-retransmission method, a picture located on the right according to an adaptive retransmission method is clean since retransmission of a few frames in which errors are detected is not allowed.

FIG. 14 shows experimental pictures in a WLAN environment having bad quality. In the WLAN environment having bad quality, many errors are detected, and picture quality is largely changed according to which method is selected. Therefore, referring to FIG. 14, a picture located on the left according to the retransmission method is mostly damaged due to retransmission of a plurality of frames in which errors are detected. A picture located in the center according to the non-retransmission method is mostly damaged since retransmission of a plurality of frames in which errors are detected is not allowed. Also, a picture located on the right according to the adaptive retransmission method is relatively clean since retransmission of frames in which errors are detected is adaptively not allowed.

The present invention may be embodied in a general-purpose computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present invention may be embodied as a computer-readable medium having a computer-readable program code unit embodied therein for causing a number of computer systems connected via a network to effect distributed processing.

As described above, according to embodiments of the present invention, optimal pictures can be provided without regard to a state of a WLAN environment by adaptively allowing retransmission frames in which errors are detected. That is, a network throughput is maximized without regard to a state of a WLAN environment. Particularly, in a bad WLAN environment, retransmission of 15% of total frames occurs in opposition to occurrence of retransmission of 90% of total frames. Also, while an entire picture is not shown when a conventional method is applied, an entire picture can be shown even if a little corruption occurs when the embodiments of the present invention are applied.

Also, when retransmission is not allowed in a MAC layer, CPU performance is increased by disabling an IP checksum and a UDP checksum of an IP layer and a UDP layer, respectively.

While this invention has been particularly shown and described with reference to preferred embodiments thereof, it will be understood by those skilled in the art that various changes in form and details may be made therein without departing from the spirit and scope of the invention as defined by the appended claims. Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A retransmission control method comprising:
comparing a number of errors in a frame received from a server with a predetermined threshold; and
adaptively not allowing retransmission of the frame on the basis of the comparison result.

2. The retransmission control method of claim 1, wherein the adaptively not allowing the retransmission of the frame comprises transmitting to the server an ‘ACK’ indicating that the frame is normally received.

3. The retransmission control method of claim 1, wherein the adaptively not allowing the retransmission of the frame comprises disabling checksum functions of at least one layer in which the frame is processed.

4. The retransmission control method of claim 1, further comprising:
adaptively allowing the retransmission of the frame on the basis of the comparison result.

5. The retransmission control method of claim 4, wherein the adaptively allowing the retransmission of the frame comprises waiting to receive a frame retransmitted from the server during an extended interframe space (EIFS).

6. The retransmission control method of claim 1, further comprising:
determining the kinds of data included in the frame, wherein
the comparing the number of errors in the frame with the predetermined threshold comprises comparing the number of errors in the frame in which it is determined that the frame includes AV data with the predetermined threshold.

7. A retransmission control apparatus comprising:
a comparator comparing a number of errors in a frame received from a server with a predetermined threshold; and
a retransmission disallowance unit adaptively not allowing retransmission of the frame on the basis of the comparison result.

8. The retransmission control apparatus of claim 7, wherein the retransmission disallowance unit does not allow the retransmission of the frame by transmitting to the server an ‘ACK’ indicating that the frame is normally received.

9. The retransmission control apparatus of claim 7, wherein the retransmission disallowance unit does not allow the retransmission of the frame by disabling checksum functions of at least one layer in which the frame is processed.

10. A computer readable medium having recorded thereon a computer readable program for performing a retransmission control method comprising:
comparing a number of errors in a frame received from a server with a predetermined threshold; and
adaptively not allowing retransmission of the frame on the basis of the comparison result.

11. A retransmission control method comprising:
comparing a number of errors in a frame received from a server with a retransmission disallowance threshold for not allowing retransmission of the frame; and
changing a retransmission disallowance mode in which retransmission of the frame is not allowed to a retransmission allowance mode in which retransmission of the frame is allowed, if it is determined that the number of errors in the frame is greater than the retransmission disallowance threshold based on the comparison result.

12. The retransmission control method of claim 11, further comprising:
not allowing the retransmission of the frame when the change to the retransmission allowance mode is finished in the changing of the retransmission disallowance mode to the retransmission allowance mode.

13. The retransmission control method of claim 12, wherein the not allowing the retransmission of the frame comprises not allowing the retransmission of the frame if it is determined that the number of errors in the frame is not greater than the retransmission disallowance threshold based on the comparison result.

14. The retransmission control method of claim 11, wherein:
the comparing of the number of errors in the frame with the retransmission disallowance threshold comprises comparing the number of errors in the frame with a retransmission allowance threshold for allowing retransmission of the frame, and
the changing the retransmission disallowance mode to the retransmission allowance mode changes the retransmission allowance mode to a retransmission disallowance mode if it is determined that the number of errors in the frame is smaller than the retransmission allowance threshold based on the comparison result.

15. The retransmission control method of claim 14, further comprising:
allowing the retransmission of the frame when the change to the retransmission disallowance mode is finished in the changing of the retransmission disallowance mode to the retransmission allowance mode.

16. The retransmission control method of claim 15, wherein the allowing the retransmission of the frame comprises allowing the retransmission of the frame if it is determined that the number of errors in the frame is not smaller than the retransmission allowance threshold based on the comparison result.

17. A retransmission control apparatus comprising:
a comparator comparing a number of errors in a frame received from a server with a retransmission disallowance threshold for not allowing retransmission of the frame; and
a mode changer changing a retransmission disallowance mode in which retransmission of the frame is not allowed to a retransmission allowance mode in which retransmission of the frame is allowed, if it is determined that the number of errors in the frame is greater than the retransmission disallowance threshold based on the comparison result.

18. The retransmission control apparatus of claim 17, further comprising:
a retransmission disallowance unit not allowing the retransmission of the frame when the change to the retransmission allowance mode is finished by the mode changer.

19. The retransmission control apparatus of claim 18, wherein the retransmission disallowance unit does not allow the retransmission of the frame if it is determined that the number of errors in the frame is not greater than the retransmission disallowance threshold based on the result compared by the comparator.

20. A computer readable medium having recorded thereon a computer readable program for performing a retransmission control method comprising:
comparing a number of errors in a frame received from a server with a retransmission disallowance threshold for not allowing retransmission of the frame; and
changing a retransmission disallowance mode in which retransmission of the frame is not allowed to a retransmission allowance mode in which retransmission of the frame is allowed, if it is determined that the number of errors in the frame is greater than the retransmission disallowance threshold based on the comparison result.

21. A retransmission control apparatus for optimum image processing, comprising:
a data determiner to determine the kinds of data in a frame received from a server, and
a comparator to compare the number of errors in the frame with a predetermined error threshold, when it is determined that the frame includes AV data.
